(19) United States
(12) Patent Application Publication
(10) Pub. No.: US 2008/0257253 A1
(43) Pub. Date: Oct. 23, 2008

(54) Rotary Gauge Structure

(76) Inventor: Shen-Mu Kao, Taipei (TW)

Correspondence Address: HDSL, 4331 STEVENS BATTLE LANE, FAIRFAX, VA, 22033, US

(21) Appl. No.: 12/103,005

(22) Filed: Apr. 15, 2008

(30) Foreign Application Priority Data
Apr. 19, 2007 (TW) 096113726

(51) Int. Cl. G01D 11/28; G01L 7/00

(52) U.S. Cl. 116/288; 73/756

(57) ABSTRACT

A rotary gauge structure includes a gauge, a base, a rotary part, and a connecting component. The gauge is installed on the top of the base, and below the base is outer thread for rotary part to sleeve on the outside and clamped between gauge and rotary part. Inside the base is the inner thread, the rotary part is a ring structure for connecting to the thread of the gauge, and the top of rotary part is installed with several grooves for fitting with oil seal. The connecting component, with top installed with outer thread, is for fitting with the base of gauge, and the bottom is for connecting to mechanical equipment. The installation of rotary part for the gauge is capable of rotating 360 degrees freely so that the gauge is not restricted in displaying at fixed angle for added convenience in functionality.

### BACKGROUND OF THE INVENTION

(a) Field of the Invention

A rotary gauge structure of the present invention involves a kind of improvement technology for the application of hydraulic sensor gauge, particularly the structure for the gauge having the function of rotating 360 degrees freely.

(b) Description of the Prior Art

The hydraulic or air pressure mechanical equipments in the market mostly require the installation of pressure gauges in order to obtain the knowledge of whether the pressure during operating processes are normal or not. The pressure gauge of prior technology often has only single-side display function and at a fixed angle. Its structure is mainly to install a pressure sensor element, a caliber plate, and an indicator needle in the pressure gauge. As it only has a single display and a fixed angle, the user could only view the display from a single, fixed direction if intend to read the pressure from the gauge. If the user is located behind the back of the display of the pressure gauge, he would have to return to the front of the pressure gauge display in order to read the pressure reading. This has created inconvenience during work, and further prevents the user from readying the pressure in the first minute, resulting in danger.

Subsequently, though the pressure gauges with dual display are introduced into the market, the surface of the dual display pressure gauge is still at fixed angles, rendering difficulty in reading pressure values.

In view of this, the inventor has studied and completed the present invention.

### SUMMARY OF THE INVENTION

The purpose of the present invention of rotary gauge structure is mainly in providing a kind of non-fixed angle, freely rotating gauge structure. When taking the reading from the rotary gauge, the work will not be affected by the fixed display structure in order to achieve convenience in usage and the work efficiency can be improved.

To achieve the above stated purpose, the present invention consists of a rotary gauge structure containing a gauge, a base, a rotary part, and a connecting component. The gauge, installed on the base, has outer thread at its bottom; inside the gauge there is a sensor element, caliber plate, and needle; the top is installed with a gauge cover; the base is installed at the bottom of the gauge, sleeved on the rotary part, is a hollow structure with several grooves on it for the sealing with oil sleeve, and inside has inner thread for matching with the outer thread of the gauge and at the same time connected in between the rotary part and the gauge; the connecting component, installed at the bottom of the rotary part, having outer thread on the outer peripheral for connecting with base, and its bottom is for connecting to the equipment waiting to be measured.

When assembling the present invention, the rotary part is placed tightly with oil seal inside the base, then the gauge is connected to the rotary part; the base is placed in between the gauge and rotary part so that the rotary part will not slip out of the base while the rotary part could allow the gauge to rotate. With this, the gauge has the capability of rotating freely, even when the user is located behind the pressure gauge of beside it; it also allow the adjustment of the display at the first instance in order to obtain the pressure reading in order to achieve the convenience in reading for the pressure gauge structure.

### BRIEF DESCRIPTION OF THE DRAWINGS

FIG. 1 is the prospective view of the present invention.

FIG. 2 is the perspective view of the exploded parts of the present invention.

FIG. 3 is the cross-sectional view of the exploded structure of the present invention.

FIG. 4 is the cross-sectional view of the present invention.

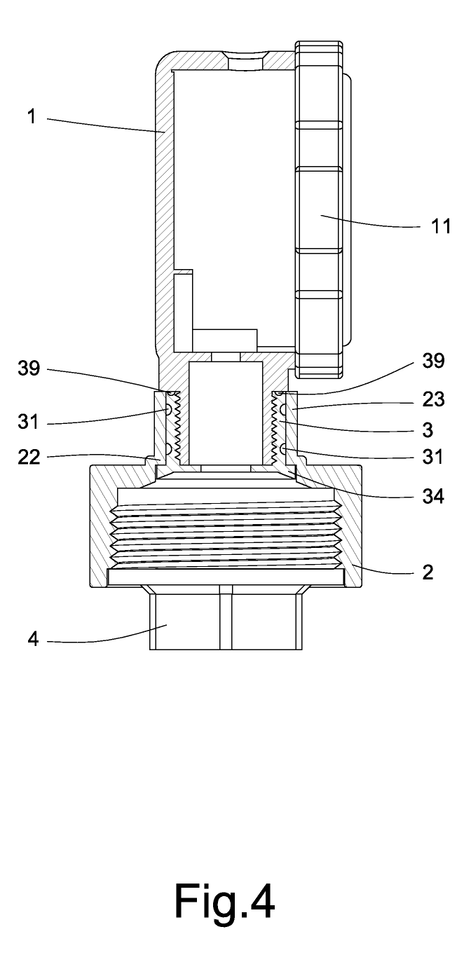

FIG. 5 is the illustration of the rotary gauge of the present invention in the action state.

### DETAILED DESCRIPTION OF THE PREFERRED EMBODIMENTS

In terms of the assembly of the rotary gauge structure of the present invention and the performance it generates, below is the description of a preferred embodiment of the present invention together with illustrations.

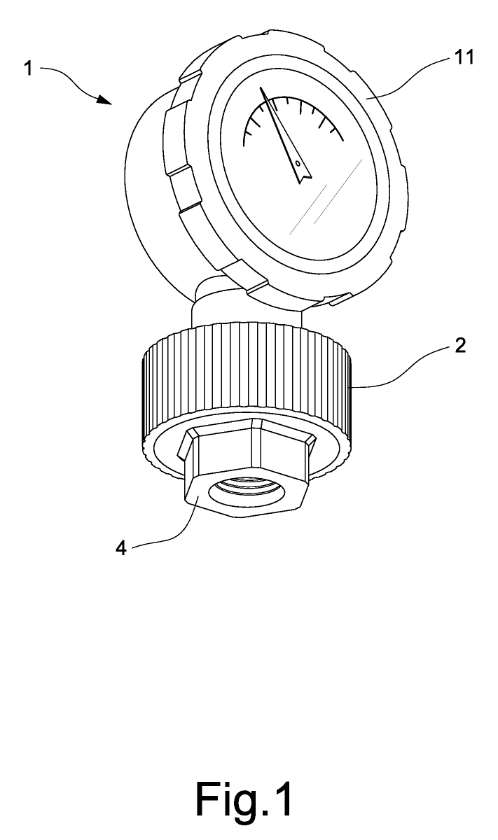

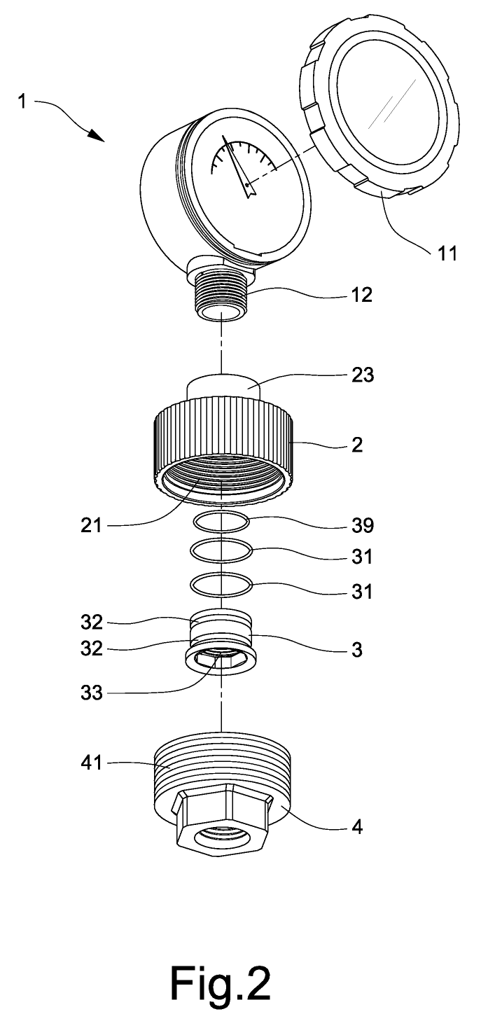

First please refer to the illustrations of FIGS. 1 and 2 showing the rotary gauge structure of the present invention. The gauge mainly consists of a gauge 1, a base 2, a rotary part 3, and a connecting component 4; gauge 1, installed on top of base 2, with its inside having structure of prior technology including a sensor component, a caliber plate, and a needle as well as a cap 11 assembled at the top and an outer thread 12 at the bottom of the gauge 1; base 2, installed below the gauge 1, sleeved on the rotary part 3, with its inside having inner thread 21, wherein the base 2 structure comprises a ring stopper edge 22 and a pipe 23; rotary part 3, a ring structure, with its outer rim having several grooves 32, wherein the grooves 32 are used for the assembly with oil seal 31, and the rotary part 3 through assembly with oil seal 31 is placed into the pipe 23 and using the oil seal 31 to form tight assembly; in addition, the bottom of the rotary part 3 is installed with stopping ring 34, and the inside of the rotary part 3 has inner thread 33, the inner thread 33 can be fit to the outer thread 12 below the gauge 1; connecting component 4, installed below seat 2, with its top having outer thread 41, the outer thread 41 can be fit to the inner thread 21 of the base 2.

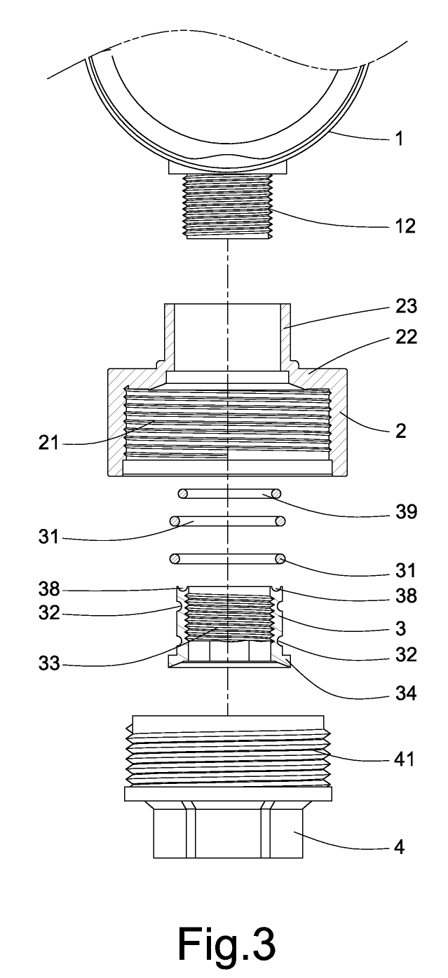

Again, please refer to FIGS. 3 & 4. When assembling the present invention, the rotary part 3 together with oil seal 31 is placed into pipe 23 from the ring stopper edge 22 below the base 2, forming the tight assembly relationship of rotary part 3 and pipe 23, then the gauge 1 is screwed to the rotary part 3 and the base 2 is clamped between the gauge 1 and rotary part 3, wherein the rotary part 3 and gauge 1 can rotate freely with respect to pipe 23, and as the stopping ring 34 of the rotary part 3 matches the ring stopping edge 22, resulting in the state where the rotary part 3 is not able to escape from base 2.

When using the present embodiment in hydraulic gauge, as the oil will fill up the gauge 1, the base 2, and the connecting component 4, in order to prevent the oil from leaking when rotating the gauge, the groove 32 and oil seal 31 are installed in the rotary part 3 and fit tightly inside the pipe 23 for excellent sealing effect.

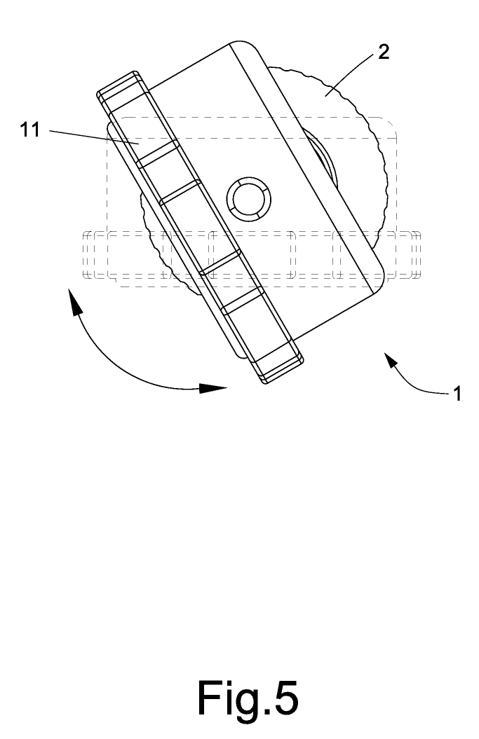

Please refer to FIG. 5 showing the gauge 1 of the present invention can rotate freely with respect to the base 2 with no fixed angle, which has the convenient performance never seen before.

The gauge of the present invention can be used in hydraulic pressure gauge, and the display of the gauge can be needle type or digital type.

As shown in FIGS. 2 and 3, the rotary part 3 can be installed with groove 38 and oil seal 39 can be placed inside the groove 38 to ensure tight sealing.

I claim:

1. A rotary gauge structure comprising:
a gauge, for displaying readings;
a base, installed below the gauge;
a rotary part, placed between the base and connecting to the gauge and not escaping from the base, wherein the rotary part and the gauge are jointly moved and rotate with respect to the base.

2. The rotary gauge structure as stated in claim 1, wherein below the gauge there is outer thread, and in the rotary part there is inner thread, and the outer thread is fit to the inner thread.

3. The rotary gauge structure as stated in claim 1, wherein the rotary part has several grooves installed, with oil seal placed between grooves.

4. The rotary gauge structure as stated in claim 1, wherein the connecting component is assembled below the base.

5. The rotary gauge structure as stated in claim 4, wherein inner thread is installed inside the base, and outer thread is installed on the connecting component, the base is screwed onto the connecting component.

6. The rotary gauge structure as stated in claim 1, wherein the base is installed with a ring stopping edge, and the rotary part is installed with the stopping ring.

7. The rotary gauge structure as stated in claim 1, wherein the base further contains a pipe for housing the rotary part.

8. The rotary gauge structure as stated in claim 1, wherein the gauge is used for hydraulic pressure gauge.

9. The rotary gauge structure as stated in claim 1, wherein the display reading is either needle style or digital type.
